(19) United States
(12) Patent Application Publication
(10) Pub. No.: US 2007/0292706 A1
(43) Pub. Date: Dec. 20, 2007

(54) Multilayer, Plate-Shaped Composite Material For Producing Cookware Suitable For Induction Stoves By Plastic Deformation

(76) Inventors: Markus Spring, Eschlikon (CH); Norbert E. Hoffstaedter, Icking (DE)

Correspondence Address: OLSON & HIERL, LTD., 20 NORTH WACKER DRIVE, 36TH FLOOR, CHICAGO, IL, 60606, US

(21) Appl. No.: 11/661,227

(22) PCT Filed: Aug. 26, 2004
(86) PCT No.: PCT/CH04/00539

§ 371 Date: Feb. 26, 2007

(51) Int. Cl. B32B 15/01; A47J 36/02

(52) U.S. Cl. 428/576

(57) ABSTRACT

The invention relates to a plate-shaped composite material of several metal layers (1, 2, 3) for producing cookware suitable for induction stoves by deep drawing, wherein the composite material comprises two metallic outer layers (1, 2) and at least one metallic core layer (3) arranged between the outer layers (1, 2), wherein at least one of the two outer layers (1) is formed of aluminum or an aluminum alloy and the core layer (3) adjacent to this outer layer is formed of a ferromagnetic metal or a ferromagnetic metal alloy. The composite material composed in such a way can be coated on the outer layer which consists of aluminum or an aluminum alloy in a simple and cost efficient way. By this it becomes possible to produce high-quality cookware suitable for induction stoves with a desired coating at low cost.

### TECHNICAL FIELD

The invention relates to a multilayer, plate-shaped composite material for producing cookware suitable for induction stoves by deformation, a round blank made of the composite material, a cookware blank produced or producible from the composite material or the round blank as well as cookware produced or producible from the composite material, the round blank or the cookware blank according to the preambles of the independent patent claims.

### BACKGROUND ART

In the large scale industrial production of high quality cookware suitable for induction stoves it is nowadays common to produce cookware blanks by deep drawing of round blanks of multi layer metallic composite material and then to further process them by post processing and the mounting of handle elements into ready-to-be-sold cookware. Thereby the composite material of which the round blank is made comprises a core of aluminum or copper and at least one outer layer of ferritic stainless steel, which forms, after the deep drawing of the round blank, the outer side of the cookware blank produced in such a way and which serves during cooking on the induction stove for the generation of the cooking heat. However, this outer layer has the disadvantage that the application of a coating, for example an anti-adhesive coating of Teflon, is difficult regarding the process technique and is costly such that the design possibilities regarding the outer surface of the cookware are limited and this cookware is practically completely produced with stainless steel outer surfaces.

### DISCLOSURE OF THE INVENTION

Hence, there is the problem to provide a multilayer, plate-shaped composite material, a composite material round blank, a cookware blank as well as an article of cookware, which do not have the disadvantages of the state of the art or which avoid these at least partially.

This problem is solved by the multilayer, plate-shaped composite material, the round blank, the cookware blank as well as the article of cookware according to the independent claims.

Accordingly, a first aspect of the invention concerns a plate-shaped composite material of several metal layers, which is deep drawable in such a way that round blanks, i.e. circular or oval plates, of this composite material can be formed by plastic deformation without destroying of individual layers, e.g. by deep drawing, stretch-forming or compression-molding, into induction stove suitable cookware blanks with a bottom area and a wall area enclosing this bottom area. Thereby the composite material comprises two metallic outer layers and at least one metallic core layer arranged between the outer layers, wherein at least one of the two outer layers, the according to the claims first outer layer, is formed of aluminum or an aluminum alloy and the core layer adjacent to said first outer layer, the according to the claims first core layer, is formed of a ferromagnetic metal or a ferromagnetic metal alloy. The composite material constructed in such a way can be provided with a coating, e.g. of Teflon, with a decorative coating or with a hard ionization on the outer layer consisting of aluminum or an aluminum alloy in a regarding the technique of the process simple and cost-efficient way, which is preferably done yet before the deforming, e.g. by deep drawing, e.g. after the punching out of the round blank from a composite material plate. By this it is made possible to produce high quality cookware suitable for induction stoves with a desired coating at relatively low cost.

In a preferred embodiment of the composite material the according to the claims second outer surface is made of a ferritic or austenitic stainless steel.

In a further preferred embodiment of the composite material the according to the claims first outer layer of aluminum or an aluminum alloy has a thickness of less than 100 μm, preferably of less than 40 μm, and more preferably of less than 20 μm, such that an as minor as possible shielding of the according to the claims first core layer of ferromagnetic material regarding the inductive field created by the inductive stove results.

If the second outer layer of the composite material is also of aluminum or an aluminum alloy, both outer surfaces can be provided with a coating in a simple and cost efficient way. Thereby, it is preferred if both outer layers are identical regarding material and/or layer thickness, since by this the bimetal-effect and therewith the shape distortion of the bottom of cookware made of this composite material can be reduced.

The according to the claims first core layer, which is directly adjacent to the according to the claims first metallic outer layer, consists preferably of a stainless steel alloy, of a non-stainless steel alloy or of nickel or of a nickel alloy, wherein the first and the last variant have the advantage that a subsequent uncovering of this first core layer in the area of the bottom of a cookware blank made from this material for an improving of the induction field penetration, for example by removing the according to the claims first outer layer by chemical processes, e.g. etching, or mechanical processes, in particular cutting, e.g. turning, is possible without resulting later in corrosion problems.

In a further preferred embodiment the composite material comprises adjacent to the according to the claims first core layer at least a second core layer, which has a higher heat conductivity than the first core layer and which is preferably of copper or aluminum or an alloy of one of these metals. By this, a composite material can be provided which supports a uniform heat distribution.

Regarding this matter, it is preferred if between the first core layer and the second outer layer a further core layer is arranged, which has a higher stability than the second core layer, and in particular that this further core layer is made of titanium, stainless steel or steel. By this, a composite material results with very high mechanical stability.

Preferably between the first core layer and the second outer layer a composite of several further core layers of different alloys of the same metal is arranged, namely preferably of different aluminum alloys or of pure aluminum and aluminum alloys. By this, the deep drawing quality of the composite material can be improved and in particular the formation of a so called “orange-peel skin” during the deep drawing, which would have to be removed consecutively by laborious mechanical post processing, can be prevented.

Regarding this matter, it is an advantage, if the composite of further core layers has an odd number of layers, e.g. if it is three-, five-, seven- or nine-layered, and preferably has in addition, when starting from a middle layer, a symmetrical layer arrangement regarding the material of the alloy and/or the thickness of the layer, since in such a way a structure results which is as uniform as possible and which causes when heated practically no bimetal effect.

If the composite material comprises two preferably identical composites of several further core layers made of different alloys of the same metal, namely preferably of different aluminum alloys or of pure aluminum and aluminum alloys, and arranged between these a further core layer of an other metal or an alloy of an other metal, optimum properties regarding deep drawing behaviour, stability and heat conductivity of the composite material can be achieved.

In yet another preferred embodiment the composite material has, when starting from a middle core layer, a symmetrical or laterally reversed build-up regarding the layers of material and/or the thickness of the layers, such that practically no bimetal effect results during heating or cooling and a bulging of the bottoms of cookware made of this composite material during the cooking is avoided as far as possible.

Regarding this matter, the middle core layer has preferably a higher stability than a core layer adjacent to it and is in particular formed of steel, stainless steel or titanium or an alloy thereof, since by this the mechanical stability can be significantly improved.

In yet an other preferred embodiment the composite material comprises on the according to the claims first outer layer or on both outer layers a coating, e.g. of Teflon, whereby the deep drawing is made easier and a subsequent coating of a cookware blank made from this composite material can be omitted.

A second aspect of the invention concerns a round blank made of the composite material according to the first aspect of the invention, of which cookware blanks according to the invention can be produced by deep drawing. The round blank can be provided with a coating, e.g. an anti-adhesive coating of Teflon, on one or both sides, wherein the coating can also have been applied after the punching out of the round blank from a composite material plate according to the invention. Such round blanks can be automatically coated and deep drawn in today known industrial large-scale plants for production of coated aluminum cookware, such that relatively small production costs and a flexible production result.

A third aspect of the invention concerns a cookware blank producible or produced of the composite material according to the first aspect of the invention or the round blank according to the second aspect of the invention. The cookware blank comprises a bottom part and a wall area surrounding the bottom part and may be provided on its inner side and/or on its outer side with a coating, in particular with an anti-adhesive coating, e.g. of Teflon. Such cookware blanks can be produced in a cost efficient manner by plastic deformation, preferably deep drawing, of the composite material according to the invention and result, after final processing, e.g. turning off the end faces and affixing of handle elements, is performed, in cookware according to the invention of high quality suitable for induction stoves, which constitute a fourth and last aspect of the invention.

### BRIEF DESCRIPTION OF THE DRAWINGS

Further embodiments, advantages and applications of the invention become apparent from the dependent claims and from the following description making reference to the annexed figures, wherein:

FIG. 1 to 6 show in each case a section through a composite material according to the invention; and

FIG. 7 shows a section through a half of a cookware blank according to the invention made of a further composite material according to the invention.

### MODES FOR CARRYING OUT THE INVENTION

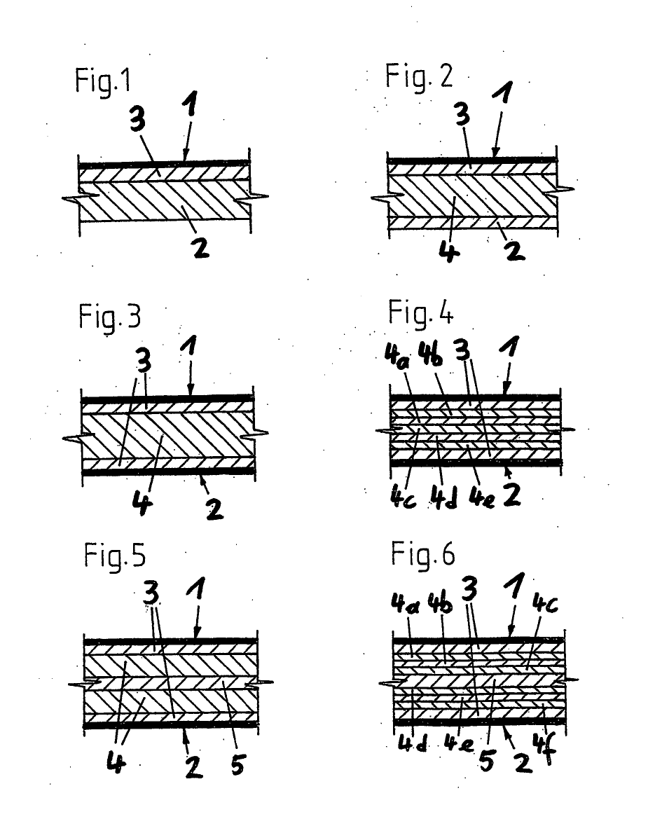

FIG. 1 shows a section through a first multilayer, plate-shaped composite material according to the invention for production of cookware suitable for induction stoves. As can be recognized, the composite material consists of an according to the claims first outer layer 1 of aluminum, which has a layer thickness of about 20 μm, of an according to the claims second outer layer 2 of aluminum, which has a layer thickness of about 2.5 mm, as well as of an according to the claims first core layer 3 of ferromagnetic carbon steel arranged between these layers, which has a layer thickness of about 0.5 mm. The layers 1, 2, 3 are deeply connected with each other by roll-bonding such that the composite material can be deep drawn without the layers 1, 2, 3 separating from each other. In the production of cookware suitable for induction stoves by deep drawing of a round blank of this material, it is to be regarded that the material is preferably processed such that the thin first aluminum outer layer 1 forms the outer surface of the cookware. Otherwise the thick second aluminum outer layer 2 in the bottom area of the cookware would have to be reduced in its thickness or be completely removed after the deep drawing, e.g. by turning, since otherwise it would shield off the induction field from the ferromagnetic core layer 3 and the cookware would thereby be unsuitable for induction stoves.

FIG. 2 shows a section through a second composite material according to the invention, which is different from the one shown in FIG. 1 in that the according to the claims first core layer 3 is formed of a ferritic stainless steel instead of carbon steel and on the aluminum layer 2 which is about 2.0 mm thick and which forms in FIG. 1 the second outer layer, an about 0.5 mm thick layer of ferritic stainless steel is arranged, which forms here the according to the claims second outer layer 2 such that the aluminum layer here being covered by it, which is about 2.0 mm thick, represents now an according to the claims second core layer 4.

FIG. 3 shows a section through a third composite material according to the invention, which differs from the one shown in FIG. 2 solely in that, on the about 0.5 mm thick layer of ferritic stainless steel, which in FIG. 2 forms the second outer layer 2, an about 20 μm thick layer of aluminum is arranged, which here forms the second outer layer 2 such that the about 0.5 mm thick layer of ferritic stainless steel which is here covered by it, now forms a ferromagnetic core layer 3 as well. In a variant of the composite material shown in FIG. 3 it is also possible that the last mentioned layer is made of an other material instead of a ferritic stainless steel, e.g. of a carbon steel, and/or that it has another layer thickness.

FIG. 4 shows a section through a forth composite material according to the invention, which differs from the one shown in FIG. 3 solely in that there is instead of the second core layer 4 of aluminum shown in FIG. 3 a composite of several further core layers 4a, 4b, 4c, 4d, 4e of different aluminum alloys, wherein the core layers 4a, 4b, 4c, 4d, 4e are, in each case, about 0.4 mm thick and the core layers 4a and 4d as well as 4b and 4e are, in each case, formed of identical alloys, such that starting from the middle layer 4c a symmetrical or laterally reversed build-up of the composite results. It is also possible to design the core layers 4a, 4b, 4c, 4d and 4e with differing thickness, e.g. the core layers 4a and 4d about 0.1 mm thick, the core layers 4b and 4e about 0.2 mm thick and the core layer 4c about 1.4 mm thick. It is also possible that the core layers 4a, 4b, 4c, 4d and 4e are of pure aluminum and aluminum alloys.

FIG. 5 shows a section through a fifth composite material according to the invention, which differs from the one shown in FIG. 3 in that instead of the second core layer 4 of aluminum shown in FIG. 3, which is about 2.0 mm thick, there are two second core layers 4, which are about 1.0 mm thick, and between them there is a further core layer 5 of stainless steel which is about 0.5 mm thick, whereby the shown composite material gets a particularly high mechanical stability.

FIG. 6 shows a section through a sixth composite material according to the invention, which differs from the one shown in FIG. 5 solely in that there is instead of the two second core layers 4 of aluminum shown in FIG. 5 in each case a composite of several further core layers 4a, 4b, 4c and 4d, 4e, 4f, respectively, of different aluminum alloys, wherein the core layers 4a, 4b, 4c, 4d, 4e, 4f are in each case about 0.3 mm thick and the core layers 4a and 4f, 4b and 4e as well as 4c and 4d are in each case made of identical alloys, such that the two composites starting from the further, here about 0.6 mm thick core layer 5 result in a symmetrical or laterally reversed layer composition. Here, it is also possible to design the core layers 4a, 4b, 4c, 4d, 4e and 4f with differing thickness, e.g. the core layers 4a, 4c, 4d and 4f about 0.05 mm thick and the core layers 4b and 4e about 0.6 mm thick. It is also possible that the core layers 4a, 4b, 4c, 4d, 4e and 4f alternatingly consist of pure aluminum and an aluminum alloy.

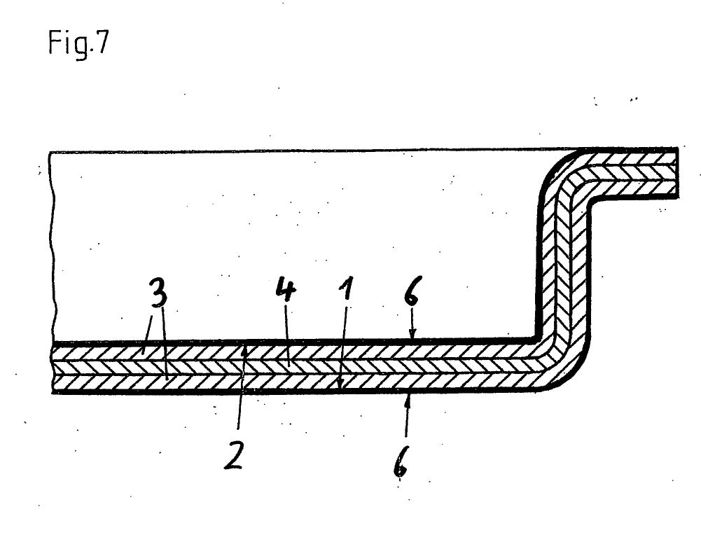

FIG. 7 shows a section through a half of a cookware blank according to the invention, which was produced by deep drawing of a round blank according to the invention from a seventh composite material according to the invention. The composite material used here differs from the one shown in FIG. 3 solely in that instead of the second core layer 4 of aluminum shown in FIG. 3, which is about 2.0 mm thick, as second core layer 4 there is a layer of copper which is about 0.8 mm thick and that on the two outer layers 1, 2 of aluminum according to the claims there is on the cookware inner side an anti-adhesive coating 6 of Teflon and on the cookware outer side a decor coating, wherein both coatings were applied to the round blank of composite material before the deep drawing.

While in the present application preferred embodiments of the invention are described, it is to be distinctly understood that the invention is not limited thereto and may also be embodied in other ways within the scope of the following claims.

1. Multilayer, plate-shaped composite material for the production of cookware suitable for induction stoves by plastic deformation, in particular deep drawing, comprising two metallic outer layers (1, 2) and at least one metallic core layer (3) arranged between the outer layers, characterized in that at least one first of the two outer layers (1, 2) is of aluminum or an aluminum alloy and the first core layer (3) adjacent to this first outer layer (1) is of a ferromagnetic metal or a ferromagnetic metal alloy.

2. Composite materials according to claim 1, characterized in that the second outer layer (2) is of a ferritic or austenitic stainless steel.

3. Composite material according to claim 1, characterized in that the first outer layer (1) has a thickness of less than 100 μm, in particular of less than 40 μm and in particular of less than 20 μm.

4. Composite material according to claim 1, characterized in that the second outer layer (2) of the composite material is also of aluminum or an aluminum alloy, and in particular that both outer layers (1, 2) are identical regarding material and/or layer thickness.

5. Composite material according to claim 1, characterized in that the first core layer (3) is of stainless steel, of a non-stainless steel or of nickel or a nickel alloy.

6. Composite material according to claim 1, characterized in that there is a second core layer (4, 4a, 4b, 4c, 4d, 4e, 4f) adjacent to the first core layer (3), which has a higher heat conductivity than the first core layer (3), and in particular that the second core layer (4, 4a, 4b, 4c, 4d, 4e, 4f) is of copper or aluminum or is an alloy of one of these metals.

7. Composite material according to claim 6, characterized in that between the first core layer (3) and the second outer layer (2) there is arranged a further core layer, which has a higher stability than the second core layer, and in particular that this further core layer is of stainless steel, steel, titanium or a titanium alloy.

8. Composite material according to claim 1, characterized in that between the first core layer (3) and the second outer layer (2) there is arranged a composite of several further core layers (4a, 4b, 4c, 4d, 4e, 4f) of different alloys of the same metal, in particular of different aluminum alloys or of pure aluminum and aluminum alloys.

9. Composite material according to claim 8, characterized in that the composite has an odd number of layers, in particular has three, five, seven or nine layers, and in particular that the composite has a starting from a middle layer symmetrical layer composition regarding alloy material and/or layer thickness.

10. Composite material according to claim 8, characterized in that the composite material comprises two composites of several further core layers (4a-4c, 4d-4f) of different alloys of the same metal, in particular of different aluminum alloys and between these there is a further core layer (5) of an other metal or an alloy of an other metal.

11. Composite material according to claim 1, characterized in that the composite material has starting from a middle core layer a symmetrical layer composition regarding layer material and/or layer thickness.

12. Composite material according to claim 11, characterized in that the middle core layer has a higher stability than a core layer adjacent to it, and in particular that it consists of steel, stainless steel or titanium or an alloy thereof.

13. Composite material according to claim 1, characterized in that on the first outer layer or on both outer layers there is arranged a coating (6), in particular a Teflon coating (6).

14-16. (canceled)

17. A multilayer, plate-shaped composite material for the production of cookware suitable for induction stoves by plastic deformation, in particular deep drawing, comprising two metallic outer layers (1, 2) and at least one metallic core layer (3) arranged between the outer layers, characterized in that at least a first of the two outer layers (1, 2) is of aluminum or an aluminum alloy and the first core layer (2) adjacent to the first outer layer (1) is of a ferromagnetic metal or a ferromagnetic metal alloy, said first outer layer (1) having a thickness of less than 20 μm,
in the second outer layer (2) of the composite material being also of aluminum or an aluminum alloy, and in both outer layers (1, 2) are identical regarding material and/or layer thickness, and
there is a second core layer (4, 4a, 4b, 4c, 4d, 4e, 4f) adjacent to the first core layer (3), which has a higher heat conductivity than the first core layer (3), and in particular that the second core layer (4, 4a, 4b, 4c, 4d, 4e, 4f) is of copper or aluminum or is an alloy of one of these metals.

18. Composite material according to claim 17, characterized in that the composite material has starting from a middle core layer a symmetrical layer composition regarding layer material and/or layer thickness.

19. Composite material according to claim 17, characterized in that on the first outer layer or on both outer layers there is arranged a Teflon coating (6).

20. A multilayer, plate-shaped composite material for the production of cookware suitable for induction stoves by plastic deformation, in particular deep drawing, comprising two metallic outer layers (1, 2) and at least one metallic core layer (3) arranged between the outer layers, characterized in that at least one first of the two outer layers (1, 2) is of aluminum or an aluminum alloy and the first core layer (3) adjacent to this first outer layer (1) is of a ferromagnetic metal or a ferromagnetic metal alloy, in that the first outer layer (1) has a thickness of less than 20 μm,
in that the second outer layer (2) of the composite material is also of aluminum or an aluminum alloy, and in particular that both outer layers (1, 2) are identical regarding material and/or layer thickness,
in that there is a second core layer (4, 4a, 4b, 4c, 4d, 4e, 4f) adjacent to the first core layer (3), which has a higher heat conductivity than the first core layer (3), and in particular that the second core layer (4, 4a, 4b, 4c, 4d, 4e, 4f) is of copper or aluminum or is an alloy of one of these metals, and
in that between the first core layer (3) and the second outer layer (2) there is arranged a composite of several further core layers (4a, 4b, 4c, 4d, 4e, 4f) of different alloys of the same metal, in particular of different aluminum alloys or of pure aluminum and aluminum alloys.

21. Composite material according to claim 20, characterized in that the composite material has starting from a middle core layer a symmetrical layer composition regarding layer material and/or layer thickness.

22. Composite material according to claim 20, characterized in that on the first outer layer or on both outer layers there is arranged a coating (6), in particular a Teflon coating (6).

23. A round blank produced from the composite material according to claim 1 for producing cookware blanks by deep drawing.

24. A round blank produced from the composite material according to claim 17 for producing cookware blanks by deep drawing.

25. A cookware blank producible or produced from the composite material or the round blank according to claim 1.

26. A cookware blank producible or produced from the composite material or the round blank according to claim 17.

27. An article of cookware, producible or produced from the composite material according to claim 1.

28. An article of cookware, producible or produced from the composite material according to claim 17.
